(19) United States
(12) Patent Application Publication
(10) Pub. No.: US 2019/0156415 A1
(43) Pub. Date: May 23, 2019

(54) FUND TRANSACTION PLATFORMS

(71) Applicant: Cooperation Loan Platform Company Limited, Taipei City (TW)

(72) Inventors: Cheng-Fu YEN, Taipei City (TW); Yu-Teng CHANG, Taipei City (TW)

(73) Assignee: Cooperation Loan Platform Company Limited

(21) Appl. No.: 16/167,758

(22) Filed: Oct. 23, 2018

(30) Foreign Application Priority Data
Nov. 22, 2017 (TW) 106140568

(51) Int. Cl. G06Q 40/02; G06Q 40/06; G06Q 20/22

(52) U.S. Cl. CPC G06Q 40/025; G06Q 20/223; G06Q 40/06

(57) ABSTRACT

A fund transaction platform includes a transaction database, a receiving module, a processing module and a transmitting module. The receiving module respectively receives a fund borrowing information from a fund borrower end and a plurality of investing information corresponding to the fund borrowing information from investor ends through a network. The processing module determines bid winning investor ends from the investor ends according to the fund borrowing information and the plurality of investing information, and produces a transaction formed information. The transmitting module respectively transmits the transaction formed information to the fund borrower end and each the bid winning investor ends through the network. The investor ends can freely determine the fund transaction conditions to conduct peer-to-peer lending on the fund transaction platform of the present application, so that the targets of financial inclusion are achieved.

### CROSS-REFERENCE TO RELATED APPLICATION

This application claims the priority of Taiwanese patent application No. 106140568, filed on Nov. 22, 2017, which is incorporated herewith by reference.

### BACKGROUND OF THE INVENTION

### 1. Field of the Invention

The present application relates to a transaction platform, especially to a fund transaction platform.

### 2. The Prior Arts

With the popularity of Internet and mobile communication devices, and the progresses of information searching and cloud computing technologies, a combination of finance and technology precipitates financial technology (FinTech), which utilizes a web platform that provides low-cost transaction environment and huge amount of real-time information to develop innovative financial modes. The traditional financial mode is an indirect financial system with banks as core, which mainly serves the clients of asset ranking in top 20 percent, and ignores the financial demands of micro-enterprises and individuals of the asset ranking in the remaining 80 percent. Some researches indicate that future financial mode has features such as: no time-space constraints, information symmetry, personalization service, disintermediation, mixed profession operation, and high efficiency, so as to achieve the targets of financial inclusion. Currently, the innovative financial modes developed by FinTech includes: third party payment, peer-to-peer (P2P) internet lending, crowdfunding, big data finance, and virtual currency.

In various innovative financial modes, the P2P internet lending is one of the most representative modes, Zopa company (U.K.) originated the P2P internet lending in 2005; Prosper company, which is the first P2P internet lender in U.S., was established in 2006, the first internet credit loan company of China arose in June 2007; since then, the P2P internet lending has become increasingly popular. So far, U.K., U.S. and China have become the top three P2P lending markets in the world, the loan funds have exceeded 10 billion U.S. dollars. The P2P internet lending means that individuals with fund demand (fund borrowers) and individuals with ability to provide fund (fund lenders) directly conduct fund transaction in a platform established by P2P internet lending company. The P2P internet lending company formulates rules for the fund transaction and provides information about the fund borrowers (such as financial proofs, credit record, fund borrowing purpose, fund borrowing amount, and maximum fund borrowing interest rate), to make both the fund borrowers and the fund lenders assess to conduct the fund transaction or not.

The innovative financial modes impact the traditional financial system, and create new profitable markets, also bring uncertain risks. As with the loan problems existing in the traditional financial system, the P2P internet lending will inevitably face the risks of loan fraud, criminal laundering, the fund borrowers overdue or unable to repay the principal and interest, and these risks will be more serious due to the nature of Internet, even disadvantages that the P2P internet lending company misappropriates the fund, closes down and absconds with the fund probably happen; therefore, the P2P internet lending company develops credit guarantee intermediary mechanism from simple information intermediary mechanism.

Due the characteristic of the P2P internet lending is the transaction of mass micro funds, a general mode that the P2P internet lending platform conducts a loan of numerous investors and huge fund amounts includes following steps: the P2P internet lending platform evaluates resources of the fund borrower and the investors, then to respectively preset different loan interest rates to the fund borrower and the investors; the investors transfer funds to the P2P internet lending platform; the P2P internet lending platform lends the funds to the fund borrower; the P2P internet lending platform obtains creditor's rights; and the P2P internet lending platform transfers the creditor's rights to the investors. In addition to doubt about the lawfulness of the P2P internet lending platform to provide the credit guarantees in the loan, aforesaid fund transaction mode that the P2P internet lending platform gets involved in both the fund borrower and investor is not a real “peer-to-peer” transaction, and the targets of financial inclusion cannot be achieved through the current internet lending platform. Therefore, to solve the technical problems that numerous people can freely determine the loan conditions of the fund transaction in the internet platform is one of major aspects of the present application.

### SUMMARY OF THE INVENTION

For the aforesaid aspects, the present application provides a fund transaction platform including a transaction database, a receiving module, a processing module and a transmitting module. The transaction database has at least an identity information of a fund borrower end and a plurality of identity information of investor ends stored therein. The receiving module receives at least a fund borrowing information from the fund borrower end and a plurality of investing information corresponding to the fund borrowing information from the investor ends through a network, wherein the fund borrowing information includes a verification information of the fund borrower end, a minimum fund borrowing amount and a maximum fund borrowing interest rate, each the investing information includes a verification information of the investor end, an investing amount and an investing interest rate, and each the investing amount is less than the minimum fund borrowing amount. The processing module connects to the transaction database and the receiving module, after determining that the verification information of the fund borrowing information and each the verification information of the investing information are respectively identical to the identity information of the fund borrower end and each the identity information of investor end, the processing module performs following steps: selecting the investing interest rates, which are less than the maximum fund borrowing interest rate, from the plurality of the investing information, setting the investing interest rates less than the maximum fund borrowing interest rate as candidate interest rates, and producing sequence of the candidate interest rates from least to greatest; accumulating the investing amount of each the candidate interest rate according to the sequence of the candidate interest rates, and producing cumulative investing amounts corresponding to the sequence of the candidate interest rates; calculating a difference between each the cumulative investing amount and the minimum fund borrowing amount, and defining the cumulative investing amounts of the differences from greatest negative value to least positive value as 1 to N cumulative investing amounts, wherein N represents an positive integer not less than 2, and the cumulative investing amount which has the difference to the minimum fund borrowing amount being 0 or the least negative value is defined as N−1 cumulative investing amount; setting the investor ends corresponding to the 1 to N cumulative investing amounts as 1 to N bid winning investor ends; and producing a transaction formed information according to the candidate interest rates and the investing amounts of the 1 to N bid winning investor ends, wherein the transaction formed information includes at least a loan interest rate, a fund borrowing amount of the fund borrower end and lending amounts of the 1 to N bid winning investor ends. The transmitting module connects to the processing module, and respectively transmits the transaction formed information to the fund borrower end and the 1 to N bid winning investor ends through the network.

In an embodiment, the transaction database has a credit limit of the fund borrower end stored therein, after the processing module determined that the verification information of the fund borrowing information is identical to the identity information of the fund borrower end, the processing module further determines whether the minimum fund borrowing amount is not greater than the credit limit; if the processing module determined yes, the transmitting module transmits the fund borrowing information to the investor ends.

In an embodiment, the N cumulative investing amount is not greater than the credit limit.

In an embodiment, the transaction database has an investment quota of each the investor end therein, after the processing module determined that the verification information of each the investing information is identical to the identity information of each the investor end, the processing module further determines whether each the investing amount is not greater than each the investment quota; if the processing module determined yes, the processing module selects the investing information of the investing interest rate less than the maximum fund borrowing interest rate, according to the investing information of the investing amount not greater than the investment quota.

In an embodiment, the transaction database has a fund borrowing page of the fund borrower end and an investing page of each the investor end stored therein, when the fund borrower end inputs the maximum fund borrowing interest rate and the minimum fund borrowing amount in the fund borrowing page to produce the fund borrowing information, the processing module writes the minimum fund borrowing amount in each the investing page; the transmitting module respectively transmits the investing pages having the minimum fund borrowing amount written therein to the investor ends, and each the investor end inputs the investing interest rate and the investing amount in the investing page to produce the investing information corresponding to the fund borrowing information.

In an embodiment, the fund borrowing information further includes a bidding deadline; before the bidding deadline, the processing module produces a bidding status table according to the plurality of the received investing information, the transmitting module transmits the bidding status table to each the investor end, and each the investor end can amend the investing interest rate or investing amount of the investing information through the network.

In an embodiment, when the receiving module receives the investing information amended by the investor end, the processing module updates the bidding status table according to the amended investing information, and the transmitting module transmits the updated bidding status table to each the investor end.

In an embodiment, the loan interest rate is selected from at least one of the candidate interest rates, and the fund borrowing amount of the fund borrower end is the minimum fund borrowing amount or the N cumulative investing amount.

In an embodiment, the fund transaction platform further includes a memory controller, respectively connecting to the transaction database and the processing module, wherein the transaction database includes a rewritable memory and an anti-rewrite memory.

In an embodiment, the memory controller stores the identity information and the fund borrowing information of the fund borrower end, and the plurality of identity information and the investing information of the investor ends in the rewritable memory, and stores the transaction formed information in the anti-rewrite memory.

In the fund transaction platform of the present application, the receiving module respectively receives the fund borrowing information and the plurality of fund borrowing information corresponding to the fund borrowing information from the fund borrower end and the investor ends through the network; the processing module determines the bid winning investor ends from the investor ends according to the fund borrowing information and the plurality of investing information, and produces the a transaction formed information including at least a loan interest rate, a fund borrowing amount of the fund borrower end and the lending amounts of the bid winning investor ends; the transmitting module respectively transmits the transaction formed information to the fund borrower end and the bid winning investor ends. Accordingly, the technical problems of one-to-many bidding and bid winning are settled, a network fund transaction platform of no time-space limited and low risk is provided, and the goals of low cost, autonomy and high yield that the inclusive finance pursues are achieved.

### BRIEF DESCRIPTION OF THE DRAWINGS

FIG. 1 is a block diagram illustrating a fund transaction platform according an embodiment of the present application;

FIG. 2 is a flow chart illustrating the fund transaction platform performing the matching stage;

FIG. 3 is a flow chart illustrating the fund transaction platform performing the bidding stage of the fund transaction;

FIG. 4 is a flow chart illustrating the fund transaction platform performing the fulfilling stage of the fund transaction; and

FIG. 5 is a block diagram illustrating a fund transaction platform according to another embodiment of the present application.

### DETAILED DESCRIPTION OF PREFERRED EMBODIMENTS

The technical features and other advantages of the present application will become more readily apparent to those ordinarily skilled in the art, by referring the following detailed description of embodiments of the present application in conjunction with the accompanying drawing.

The fund transaction platform of the present application is established in a cloud server, any person (including individuals and corporations), who is consistent with the legal requirement to independently conduct a loan transaction, transmits his/her identity information to the fund transaction platform by using an electronic device (e.g. desktop or notebook computers, or mobile communication devices of phones or pads) capable of connecting to Internet, and then he/she can apply for registration as a fund borrowing member or an investing member. After an administrator of the fund transaction platform have reviewed that the applicant's identity and credit information is consistent with the legal requirement and authenticity, the administrator stores the applicant's identity information, credit information and credit limit or investment quota that can be used for the fund transaction in a fund borrowing member area or an investing member area in the database, according to the registration of the applicant. It is worthy to mention that the fund transaction platform of the present application only allows the applicant to apply for registration as the fund borrowing member or the investing member during each the fund transaction, and does not allow the applicant apply for registration as the fund borrowing member and the investing member at the same time, so as to prevent the applicant with good financial status uses the fund transaction platform for arbitrage.

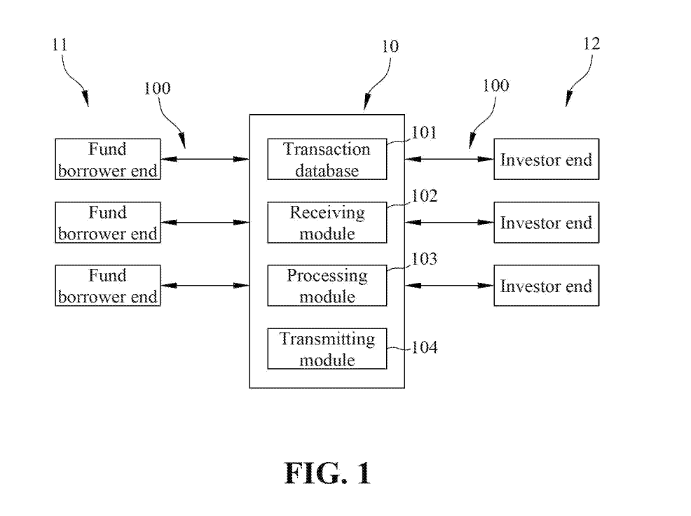

FIG. 1 is a block diagram illustrating a fund transaction platform according an embodiment of the present application. As shown in FIG. 1, a fund transaction platform 10 includes a transaction database 101, a receiving module 102, a processing module 103 and a transmitting module 104, wherein the processing module 103 connects to the transaction database 101, the receiving module 102 and the transmitting module 104. The transaction database 101 is, for example, a device of direct-attached storage (DAS) or fabric-attached storage (FAS), and has stored identity information, credit information, and credit limit or investment quota of fund borrower ends 11 and investor ends 12. The fund transaction conducted in the fund transaction platform 10 by the fund borrowing members and the investing members can be divided into a matching stage, a bidding stage and a fulfilling stage. The detailed steps of each stage are described as follows.

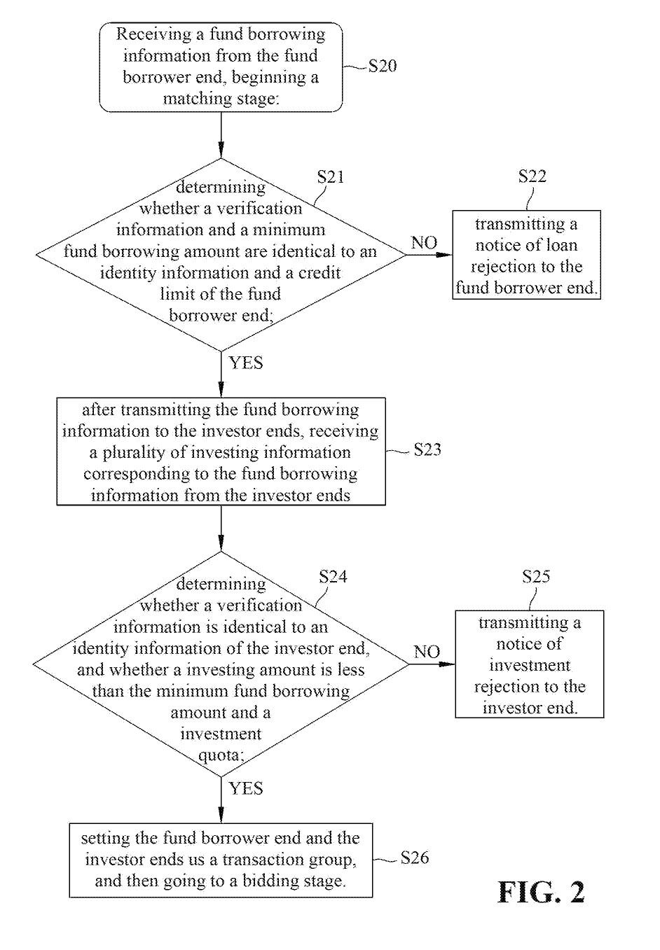

FIG. 2 is a flow chart illustrating the fund transaction platform as shown in FIG. 1 performing the matching stage. As shown in FIGS. 1 and 2, step S20, when the receiving module 102 receives a fund borrowing information including a verification information, a minimum fund borrowing amount, a maximum fund borrowing interest rate and a repayment period from a fund borrower end 11 through a network 100, the fund transaction platform 10 begins the matching stage; step S21, the processing module 103 determines whether the verification information is identical to the identity information of the fund borrower end 11, and whether the minimum fund borrowing amount is not greater than the credit limit of the fund borrower end 11; if the processing module 103 determines NO (that represents not all the condition being consistent), the matching stage goes to step S22, the processing module 103 produces a notice of loan rejection, and the transmitting module 104 transmits the notice of loan rejection to the fund borrower end 11 through the network 100; if the processing module 103 determines YES (that represents all conditions being consistent), the matching stage goes to step S23, after the transmitting module 104 transmitted the fund borrowing information to the investor ends 12, the receiving module 102 receives a plurality of investing information corresponding to the fund borrowing information from the investor ends 12 through the network 100, each the investing information includes a verification information, an investing amount and an investing interest rate of the investor end 12; step S24, the processing module 103 determines whether the verification information is identical to the identity information of the investor end 12, and whether the investing amount is less than the minimum fund borrowing amount; if the processing module 103 determines NO (that represents not all conditions being consistent), the matching stage goes to step S25, the processing module 103 produces a notice of investment rejection, the transmitting module 104 transmits the notice of investment rejection to the investor end 12 of which the investing information is not consistent with the condition through the network 100; if the processing module 103 determines YES (that means all conditions being consistent), the matching stage goes to step S26, the processing module 103 set the fund borrower end 11 and the investor ends 12 of the investing information corresponding to the fund borrowing information as a transaction group, and then the fund transaction goes to the bidding stage.

In order to improve protection for the investor ends 12, the fund borrower end 11 may input financial information to the fund borrowing information, the financial information includes a loan purpose (such as house repairs, purchase of raw material or equipment, operating turnover, litigation costs, and others), income and expenditure status, assets and liabilities, movable property intended as a loan security, and real estate and claim secured by the real estate (if any), for the investor ends 12 to assess investment risk and determine the investing interest rate. In order to provide the fund borrower end 11 an opportunity to borrow the fund at a lower loan interest rate, the maximum fund borrowing interest rate input by the fund borrower end 11 is only as a condition to filter the investing interest rates of the investor ends 12, the fund transaction platform 10 may hide the maximum fund borrowing interest rate of the fund borrower end 11; in consideration of improving the matching efficiency, the fund transaction platform 10 may disclose the maximum fund borrowing interest rate of fund borrower end 11 as a reference for the investor ends 12 to input or amend the investing interest rates.

The flow of the matching stage performed by the fund transaction platform 10 will be specifically described by an embodiment, the fund borrowing information of the fund borrower end 11 is exemplarily listed in Table 1, and the investing information of the investor ends are exemplarily listed in Table 2.

TABLE 1

| Serial number of Fund borrowing member | B001 | Credit limit: $1,000,000 |
|---|---|---|
| Verification information | Name | X |
| | Question 1 | What is your favorite? |
| | Answer 1 | (Enter the answer) |
| Minimum fund borrowing amount | $66,000 | |
| Maximum fund borrowing interest | 12% | |
| rate (Annual) | | |
| Loan purpose | (Menu) | |
| | 1. Company operating turnover | |
| | 2. House repairs | |
| | 3. Purchase of raw material or equipment | |
| | 4. Others (Please specify) | |
| Repayment | (Menu) | |
| | 1. Principal and interest by installments | |
| | 2. Principal by due and interest by installments | |
| | 3. Principal and interest by due | |
| Repayment period | 10 months | Number of installments: 10 |
| Company name and job title | Y company | |
| Income of last year | (Menu) | $33,000 |
| | 1. Salary/year | |
| | (New item) | |
| Expenditure of last year | (Menu) | $13,000 |
| | 1. Family expenses | |
| | (New item) | |
| Asset status | (Menu) | Address: |
| | 1. Real estate | |
| | (New item) | |
| Liabilities | (Menu) | |
| | 1. Mortgage | |
| | (New item) | |
| Information of assets intended as loan | (Menu) | Owner |
| security | 1. House | Address |
| | | Land area |
| | | Building area |
| | | Amount of claims |
| | | secured by the first |
| | | order mortgage |
| | | Loan balance |
| | (New item) | |

TABLE 2

| Fund borrowing member B001 | Minimum Fund | $66,000 |
|---|---|---|
| | borrowing amount | |
| | Minimum investing | $330 |
| | amount (set by the fund | |
| | transaction platform) | |
| Serial number of Investing member | L001 | Investment quota: $33,000 |
| Verification information | Name | Z |
| | Question 1 | What do you like at least? |
| | Answer | (Enter the answer) |
| Investing amount | $3,300 | |
| Investing interest rate (Annual) | The first bid | 10% |
| | (Amend) | |
| Asset status | (menu) | Account |
| | 1. Deposit | Amount |
| | (New item) | |
| Liabilities | (Menu) | |
| | 1. Amount | |
| | (New item) | |

In Tables 1 and 2 of the embodiment, the fund borrowing members and the investing members respectively answered the questions provided by the fund transaction platform 10 at the time of applications, and then stored the answers as the verification information of the fund borrower end 11 and the investor end 12. In other embodiments, the verification information can be but not limited to electronic signatures, images, fingerprints, sounds and other identifiable biometric information of the fund borrowing members or the investing members. Assume that the credit limit $1,000,000 of the fund borrowing member B001 in Table 1 and the investment quota $33,000 of the investing member L001 in Table 2 are approved, after the processing module 103 determined that the fund borrowing information from the fund borrowing member B001 (i.e. the fund borrower end 11) and the investing information from the investing member (i.e. one of the investor ends 12) are true and consistent with all the conditions, the processing module 103 adds the investing member L001 and the investing information thereof to the transaction group corresponding to the fund borrowing information of the fund borrowing member B001 (i.e. the fund borrower end 11). It is worthy to mention that the investing amount of each the investor end 12 is not subjected to special restrictions in principle; however, to avoid too little investing amount (for example, less than $300) or too little proportion (for example, less than 1%) relative to the minimum fund borrowing amount cannot meet economic benefits (for example, fund borrowing costs including interest, fund transfer fee and service fee for the fund transaction platform paid by the fund borrowing member are more than the amount paid for existing financial modes), the administrator of the fund transaction platform 10 may individually set the minimum investing amount (for example, $330, $660, $1,650, $3,300, $6,600 or $16,500) of the investor ends 12.

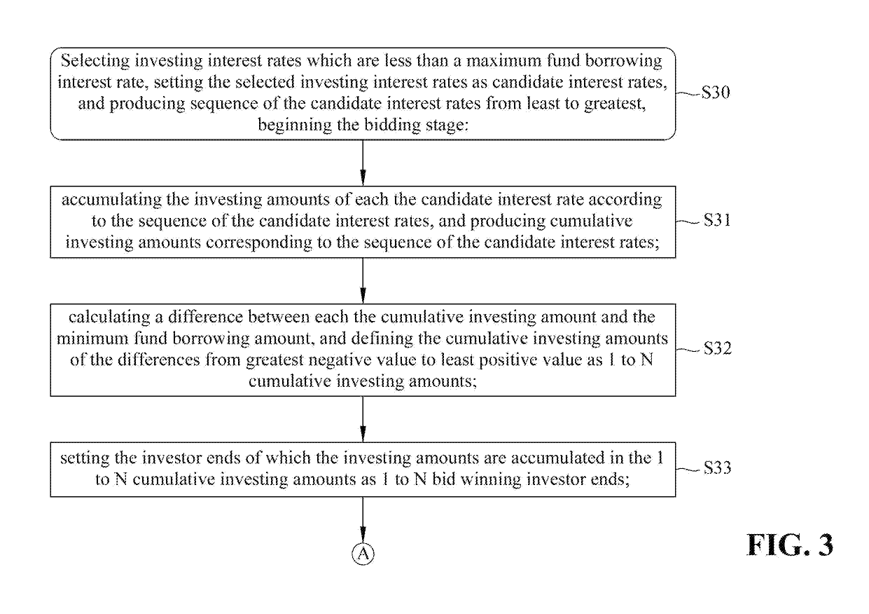

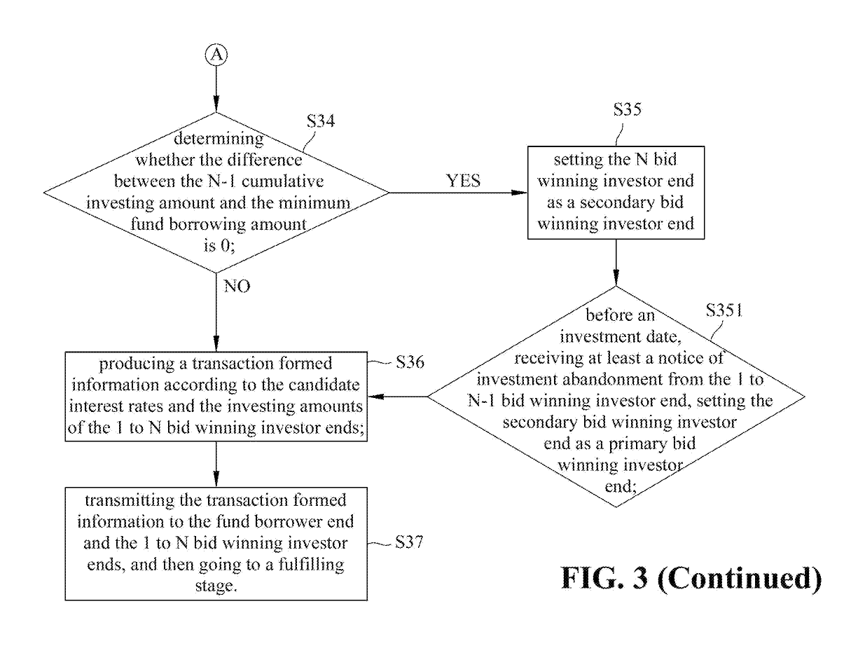

FIG. 3 is a flow chart illustrating the fund transaction platform as shown in FIG. 1 performing the bidding stage of the fund transaction. As shown in FIGS. 1 and 3, step S30, the processing module 103 selects the investing interest rates which are less than the maximum fund borrowing interest rate from the plurality of the investing information, sets the selected investing interest rates less than the maximum fund borrowing interest rate as candidate interest rates, and produces sequence of the candidate interest rates from least to greatest, the fund transaction platform 10 begins the bidding stage; step S31, the processing module 103 accumulates the investing amounts of each the candidate interest rate according to the sequence of the candidate interest rates, and produces cumulative investing amounts corresponding to the sequence of the candidate interest rates; step S32, the processing module 103 calculates a difference between each the cumulative investing amount and the minimum fund borrowing amount, and defines the cumulative investing amounts of the differences from greatest negative value to least positive value as 1 to N cumulative investing amounts, wherein the cumulative investing amount which has the difference to the minimum fund borrowing amount being 0 or the least negative value is defined as N−1 cumulative investing amount; expressions of step S32 are as follows: the cumulative investing amount=Σ (the investing amounts of the same candidate interest rate)ᵢ, wherein i is a positive integer sort of the candidate interest rate not greater than the maximum fund borrowing interest rate, i=1, 2 . . . N−1, N, N+1 . . . ; and Σ (the investing amount of the same candidate interest rate)_{N-1}≤the minimum fund borrowing amount<Σ (the investing amount of the same candidate interest rate)_{N}≤the credit limit of the fund borrower end 11, N is a positive integer not less than 2; step S33, the processing module 103 sets the investor ends 12 of which the investing amounts are accumulated in the 1 to N cumulative investing amounts as 1 bid winning investor ends 12₁ to N bid winning investor ends 12_{N}; step S34, the processing module 103 determines whether the difference between the N−1 cumulative investing amount and the minimum fund borrowing amount is 0; if the processing module 103 determines YES, the bidding stage goes to step S35, the processing module 103 sets the N bid winning investor end(s) 12_{N} as a secondary bid winning investor end(s); before an investment date, if the receiving module 102 receives at least a notice of investment abandonment from the 1 to N−1 bid winning investor ends 12₁ to 12_{N-1} through the network 100, the bidding stage goes to step S351, the processing module 103 sets the secondary bid winning investor end as a primary bid winning investor end (having same investing opportunity as the 1 to N−1 bid winning investor ends 12₁ to 12_{N-1}); step S36, the processing module 103 produces a transaction formed information according to the candidate interest rates and the investing amounts of the 1 to N bid winning investor ends 12₁ to 12_{N}, wherein the transaction formed information includes at least a loan interest rate, a fund borrowing amount and repayment period of the fund borrower end 11, and the investment date and lending amounts of the 1 to N bid winning investor ends 12₁ to 12_{N}; step S37, the transmitting module 104 respectively transmits the transaction formed information to the fund borrower end 11 and the 1 to N bid winning investor ends 12₁ to 12_{N} through the network 100; and then the fund transaction goes to the fulfilling stage.

In a special case that all the cumulative investing amounts of the investor ends 12 are equal to the minimum fund borrowing amount (i.e. the N cumulative investing amount not existing) in step S35, the processing module 103 defines the cumulative investing amounts of the differences from greatest negative value to 0 as 1 to N−1 cumulative investing amounts, and records the N cumulative investing amount as “the minimum fund borrowing amount+”, and records a number of the N bid winning investor end 12_{N} (i.e. the secondary bid winning investor end) as “0”; and the bidding stage goes to step S36.

About the lending amounts of the 1 to N bid winning investor ends, the processing module 103 directly sets the investing amounts of the 1 to N−1 investor ends 12₁ to 12_{N-1} as the lending amounts thereof, and the lending amounts of the N bid winning investor end(s) 12_{N} (or the primary bid winning investor end) depends on that a number of the N bid winning investor end 12_{N} is single or plural. If the processing module 103 determines that the number of the N bid winning investor end 12_{N} is single, the processing module 103 further determines whether the N cumulative investing amount is more than the credit limit of the fund borrower end 11; if the processing module 103 determines NO, the processing module 103 sets the investing amount of the N bid winning investor end 12_{N} as the lending amount thereof; if the processing module 103 determines YES, the processing module 103 sets a difference between the minimum fund borrowing amount (or the credit limit) and the N−1 cumulative investing amount as the lending amount of the N bid winning investor end 12_{N}. If the processing module 103 determines that the number of the N bid winning investor ends 12_{N} is plural, the processing module 103 further determines whether the N cumulative investing amount is more than the credit limit of the fund borrower end 11; if the processing module 103 determines NO, the processing module 103 sets the investing amounts of the N bid winning investor ends 12_{N} as the lending amounts thereof; if the processing module 103 determines YES, the processing module 103 subtracts the N−1 cumulative investing amount with the minimum fund borrowing amount (or the credit limit) to obtain a difference, calculates a proportion of the investing amount of each the N bid winning investor end 12_{N} accounting for the investing amounts of all the N bid winning investor ends 12_{N}, multiplies the difference and the proportion to obtain a proportional investing amount of each the N bid winning investor end 12_{N}, and sets the lending amount of each the N bid winning investor end 12_{N} according the proportional investing amount thereof, an expression in this case is: the lending amount of each the N bid winning investor end 12_{N}=(the minimum fund borrowing amount or the credit limit−the N−1 cumulative investing amount)×(the investing amount of each the N bid winning investor end 12_{N}÷the investing amounts of all the N bid winning investor ends 12_{N}). The loan interest rate of the transaction formed information can be selected from at least one of the candidate interest rates corresponding to the investing interest rates of the 1 to N bid winning investor ends 12₁ to 12_{N}, and the fund borrowing amount of the fund borrower end 11 can be the minimum fund borrowing amount or the N cumulative investing amount.

In accordance with the aforesaid embodiment, Table 3 is a bidding status table of the fund transaction, and Table 4 illustrates the transaction formed information of the bid winning investor ends in the last group of the sequence.

TABLE 3

| | | | | Minimum fund borrowing | | |
|---|---|---|---|---|---|---|
| | | | | amount $66,000 | | |
| | | Fund borrowing | | | Difference | |
| Serial number of Fund | | member B001 | | | (subtracted by | |
| transaction: T001 | | Number of | Total | Cumulative | Minimum fund | |
| | Candidate | Investing | investing | investing | borrowing | Bidding |
| Sequence | interest rate | member | amount | amount | amount) | result |
| 1 | 8% | 5 | $3,300 | $3,300 | −$62,700 | winning |
| | | | | | winning | |
| 2 | 8.5% | 5 | $6,600 | $9,900 | −$56,100 | winning |
| 3 | 9% | 5 | $9,900 | $19,800 | −$46,200 | winning |
| 4 | 9.5% | 5 | $13,200 | $33,000 | −$33,000 | winning |
| 5 | 10% | 5 | $16,500 | $49,500 | −$16,500 | winning |
| 6 | 10.5% | 5 | $19,800 | $69,300 | +$3,300 | winning |
| 7 | 11% | 5 | $23,100 | $92,400 | +$26,400 | unsuccessful |
| 8 | 11.5% | 5 | $26,400 | $118,800 | +$52,800 | unsuccessful |
| 9 | 12% | 5 | $29,700 | $148,500 | +$82,500 | unsuccessful |

TABLE 4

| Serial number of Fund transaction: T001 | | Sequence of bid winning: 06-5 | |
|---|---|---|---|
| Fund borrowing member B001 | | Investing member L030 | |
| Fund borrowing amount | $3,960 | Lending amount | $3,960 |
| Loan interest rate | 10.5% | Loan interest rate | 10.5% |
| Repayment period | 10 months | Investment date | (dd/mm/yy) |
| Number of installments | 10 | Repayment date of each | Monthly payment |
| | | installment | (e.g. on the first |
| | | | day of each month from |
| | | | January to October 2018) |
| Platform service fee (Fund | $79 | Platform service fee | $79 |
| borrowing amount × 2%) | | (Lending amount × 2%) | |

In Table 3 of this embodiment, the processing module 103 performs following steps: selecting the investing interest rates not greater than the maximum fund borrowing interest rate (12%) from the plurality of investing information, setting the selected investing interest rates as the candidate interest rates (from 8% to 12%); according to the candidate interest rates from least to greatest, producing the sequence of the candidate interest rates (from 1 to 9); calculating the total investing amounts (from $3,300 to $29,700) of each the candidate interest rate; calculating the differences between each the cumulative investing amount (from 1 to 9) and the minimum fund borrowing amount ($66,000) according to the sequence of the 1 to 9 candidate interest rates; determining the difference between the 5 cumulative investing amount ($49,500) and the minimum fund borrowing amount ($66,000) being the least negative value (−$16,500), and the difference between the 6 cumulative investing amount ($69,300) and the minimum fund borrowing amount being the least positive value (+$3,300), and the 6 cumulative investing amount being not more than the credit limit ($1,000,000); determining not any difference between each the cumulative investing amount (from 1 to 9) and the minimum fund borrowing amount being 0, sequentially setting all the investing members (30 persons) corresponding to the 1 to 6 cumulative investing amounts as 1 to 6 bid winning investor ends 12₁₋₁ to 12₁₋₅, 12₂₋₁ to 12₂₋₅, 12₃₋₁ to 12₃₋₅, 12₄₋₁ to 12₄₋₅, 12₅₋₁ to 12₅₋₅, and 12₆₋₁ to 12₆₋₅. In table 4, the processing module 103 performs following steps: determining the 1 to 6 cumulative investing amounts (from $3,300 to $69,300) are not more than the credit limit ($1,000,000); (assume the respective investing amount of the 6 bid winning investor ends 12₆₋₁ to 12₆₋₅ are the same) setting the investing amount of each the 6 bid winning investor end as the lending amount ($3,960); setting the greatest candidate interest rate (10.5%) of the 1 to 6 bid winning investor ends 12₁₋₁ to 12₆₋₅ as the loan interest rate (10.5%) of the fund transaction for the fund borrower end 11 (i.e. the fund borrowing member) and all the 1 to 6 bid winning investor ends 12₁₋₁ to 12₆₋₅ (i.e. the bid winning investing members), or setting the respective candidate interest rate as loan interest rates (8%, 8.5%, 9%, 9.5%, 10% and 10.5%) for the fund borrower end 11 and the 1 to 6 bid winning investor ends 12₁₋₁ to 12₆₋₅. The fund transaction platform 10 respectively charges the fund borrower end 11 and the 1 to 6 bid winning investor ends 12₁₋₁ to 12₆₋₅ for once service fee in the fund transaction, the service fees are calculated by multiplying a certain proportion of the fund borrowing amount and the lending amounts, the proportion is but not limited to 1%, 2%, 3%, 4% or 5%. The service fees of the fund transaction platform 10 is additional, so that the fund borrowing amount of the fund borrower end 11 and the lending amounts of the bid winning investor end 12₁₋₁ to 12₆₋₅ are unaffected.

The bidding stage performed by the fund transaction platform 10 can be a static bidding or a dynamic bidding. The static bidding means that one of the investor ends 12 cannot know the investing interest rates and investing amounts of the other investor ends 12 during the bidding stage, the processing module 103 directly determines the bid winning investor ends according to aforesaid steps at deadline of the bidding. The dynamic bidding means that the investing information and the current bidding sequence (undetermined) of each the investor end 12 are disclosed to all the investor ends 12 before the deadline of the bidding input by the fund borrower end 11. The dynamic bidding includes following steps: the processing module 103 produces the bidding status table as Table 3 (the field “Bidding result” not shown) according to the received investing information; the transmitting module 104 immediately transmits the bidding status table to each the investor end 12 through the network 100; based on the bidding situation disclosed in the bidding status table, each the investor end 12 can assess whether the investing interest rate or investing amount in the investing information needs to be amended. When the receiving module 102 receives any investing information amended by the investor end 12, the original and all previously amended bidding information of the investor ends 12 will be retained in the bidding status table; the processing module 103 updates the bidding status table according to the currently amended investing information; the transmitting module 104 immediately transmits the updated bidding status table to the investor ends 12. In the static bidding, each the investor end 12 has a probability to lend the fund at a desired loan interest rate, so the loan interest rates of the formed fund transaction can be differential (i.e. the candidate interest rate of the respective bid winning investor end 12). In the dynamic bidding, the fund borrower end 11 has probability to borrow the fund at a lower loan interest rate, so the loan interest rate of the formed fund transaction can be single (e.g. the candidate interest rate of the bid winning investor ends 12 at the last in the sequence). With the static or dynamic bidding accompanied with differential or single loan interest rate, the benefits of the fund borrower end 11 and the investor ends 12 can be balanced.

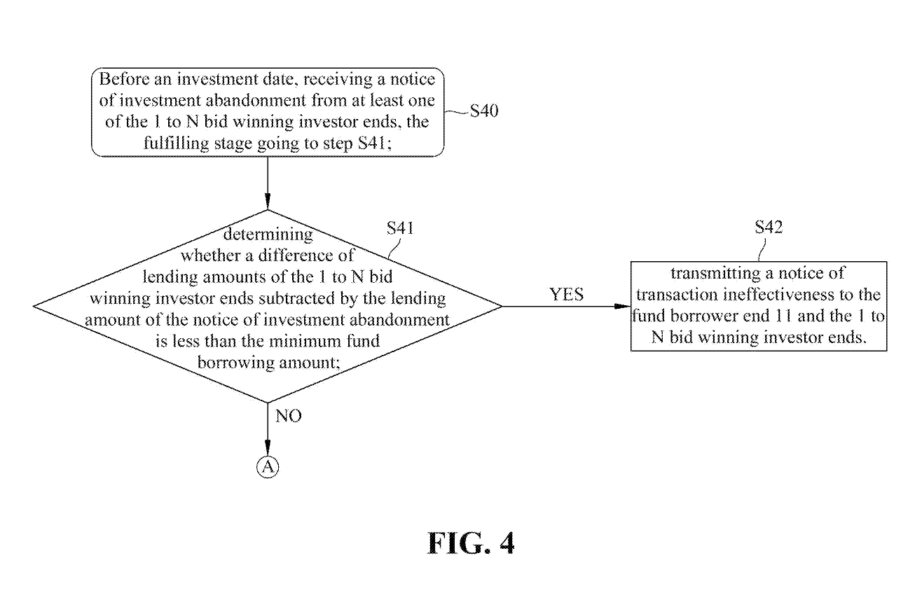

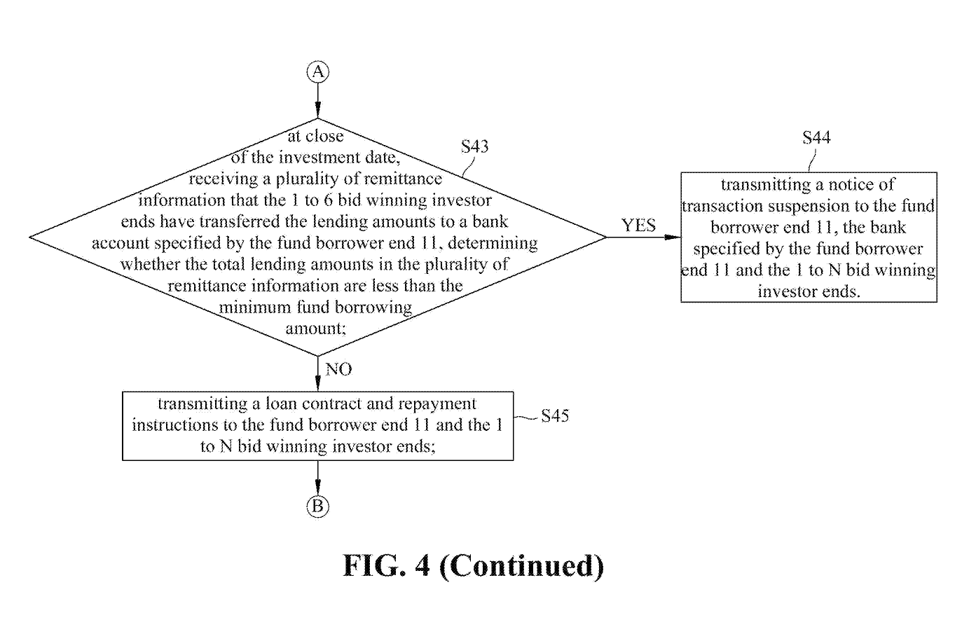

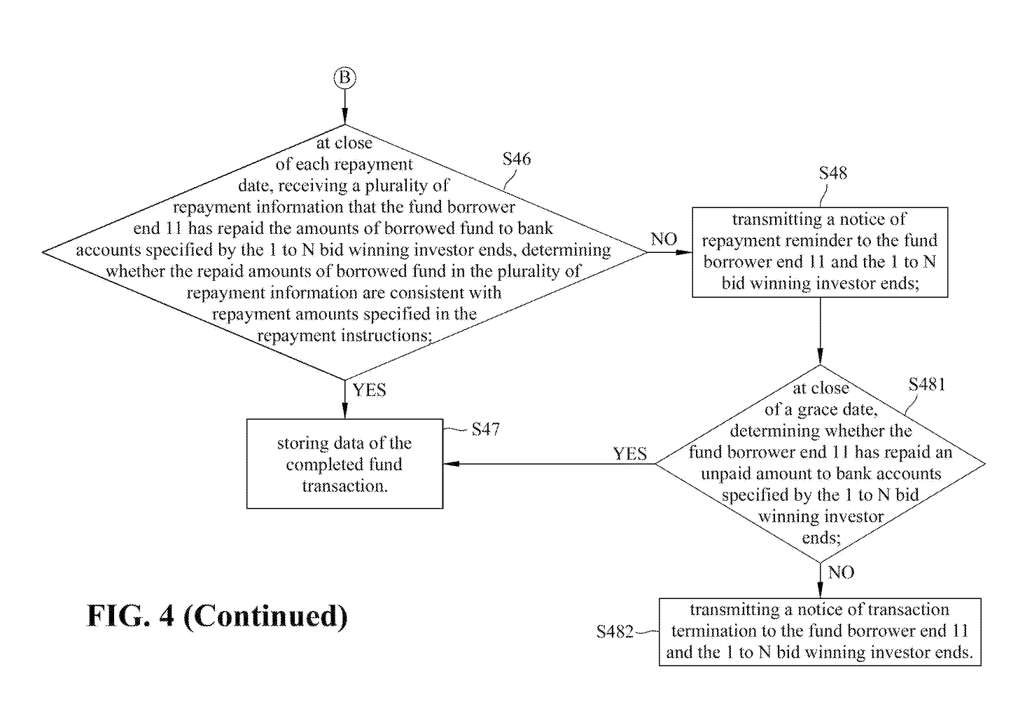

FIG. 4 is a flow chart illustrating the fund transaction platform as shown in FIG. 1 performing the fulfilling stage of the fund transaction. The investment date of the 1 to N bid winning investor ends 12₁ to 12_{N} is taken as an effective date of the fund transaction, and the final repayment date of the fund borrower end 11 is taken as a completion date of the fund transaction. As shown in FIGS. 1 and 4, step S40, before the effective date of the fund transaction, when the receiving module 102 receives a notice of investment abandonment from at least one of the 1 to N bid winning investor ends 12₁ to 12_{N}, the fulfilling stage goes to step S41, the processing module 103 determines whether a difference of the lending amounts of the 1 to N bid winning investor ends 12₁ to 12_{N} subtracted by the lending amount of the notice of investment abandonment is less than the minimum fund borrowing amount; if the processing module 103 determines YES, the fulfilling stage goes to step S42, the processing module 103 produces a notice of transaction ineffectiveness, the transmitting module 104 respectively transmits the notice of transaction ineffectiveness to the fund borrower end 11 and the 1 to N bid winning investor ends 12₁ to 12_{N}; if the processing module 103 determines NO, due that the remaining lending amounts are still not less than the minimum fund borrowing amount, the notice of investment abandonment does not affect the effectiveness of the fund transaction, the transmitting module 104 only transmits the notice of investment abandonment to the fund borrower end 11 and the 1 to N bid winning investor ends 12₁ to 12_{N}.

In accordance with the aforesaid embodiment, before the investment date, if the receiving module 102 receives the notice of investment abandonment of at least one of the 1 bid winning investor ends 12₁₋₁ to 12₁₋₅ (e.g. the 1 bid winning investor end 12₁₋₁), due the lending amounts of the formed fund transaction is $69,300, the processing module 103 determines that the investing amount (e.g. $3,300) abandoned by the 1 bid winning investor end 12₁ does not affect the effectiveness of the fund transaction (the remaining lending amount $66,000 not less than the minimum fund borrowing amount $66,000), so the transmitting module 104 only transmits the notice of investment abandonment of the 1 bid winning investor end 12₁₋₁ to the fund borrower end 11 and the 1 to 6 bid winning investor ends 12₁₋₁ to 12₆₋₅; if the receiving module 102 receives the notice of investment abandonment of at least one of the 6 bid winning investor ends 12₆₋₁ to 12₆₋₅ (e.g. the 6 bid winning investor end 12₆₋₅), due the lending amounts of the formed fund transaction is $69,300, the processing module 103 determines that the investing amount (e.g. $3,960) abandoned by the 6 bid winning investor end 12₆₋₅ affects the effectiveness of the fund transaction (the remaining lending amount $65,340 less than the minimum fund borrowing amount $66,000), and the other bid winning investor ends 12₁₋₁ to 12₆₋₄ do not yet transfer the lending amount to the bank account specified by the fund borrower end 11, the processing module 103 immediately produces the notice of transaction ineffectiveness, and the transmitting module 104 respectively transmits the notice of transaction ineffectiveness to the fund borrower end 11 and the 1 to 6 bid winning investor ends 12₁₋₁ to 12₆₋₅, so as to avoid dispute on the effectiveness of the fund transaction or how to fulfill the fund transaction.

Please refer to FIGS. 1 and 4, step S43, at close of the investment date, the receiving module 102 receives a plurality of remittance information that the 1 to 6 bid winning investor ends 12₁ to 12_{N} have transferred the lending amounts to the bank account specified by the fund borrower end 11, the processing module 103 determines whether the total lending amounts in the plurality of remittance information are less than the minimum fund borrowing amount; if the processing module 103 determines YES, the fulfilling stage goes to step S44, the processing module 103 produces a notice of transaction suspension, the transmitting module 104 respectively transmits the notice of transaction suspension to the fund borrower end 11, the bank specified by the fund borrower end 11 and the 1 to N bid winning investor ends 12₁ to 12_{N}; if the processing module 103 determines NO, the total lending amounts that the 1 to N bid winning investor ends 12₁ to 12_{N} have transferred to the bank specified by the fund borrower end 11 are not less than the minimum fund borrowing amount, it denotes that the fund transaction takes effect; the fulfilling stage goes to step S45, the processing module 103 produces a loan contract and repayment instructions according to the transaction formed information and the plurality of remittance information, the transmitting module 104 respectively transmits the loan contract and the repayment instructions to the fund borrower end 11 and the 1 to N bid winning investor ends 12₁ to 12_{N}.

In accordance with aforesaid embodiment, at close of the investment date, the receiving module 102 receives the remittance information of the 1 to 6 bid winning investor ends 12₁₋₁ to 12₆₋₅ transmitted by the fund borrower end 11 or the bank specified thereby, due the total lending amounts of the formed fund transaction are $69,300, if the processing module 103 determines that the 1 bid winning investor end 12₁₋₁ does not transfer the lending amount $3,300 to the bank account specified by the fund borrower end 11, but not affect the effectiveness of the fund transaction (i.e. the transferred lending amounts $66,000 not less than the minimum fund borrowing amount $66,000), so the processing module 103 produces the loan contract and the repayment instructions according to the transaction formed information and the remittance information including the lending amounts transferred by the 1 to 6 bid winning investor ends 12₁₋₂ to 12₆₋₅; the transmitting module 104 respectively transmits the loan contract and the repayment instructions to the fund borrower end 11 and the 1 to 6 bid winning investor ends 12₁₋₂ to 12₆₋₅. In the repayment instructions of the fund transaction, the first and second repayment dates and amounts that the fund borrower end 11 shall repay the borrowed fund to the 6 bid winning investor ends 12₆₋₁ to 12₆₋₅ are illustrated in Table 5.

TABLE 5

| | | |
|---|---|---|
| Fund transaction T001 | Fund borrowing member B001 | Fund borrowing amount $19,800 |

| | | | | | |
|---|---|---|---|---|---|
| Investing members/ | L026/12₆₋₁ | L027/12₆₋₂ | L028/12₆₋₃ | L029/12₆₋₄ | L030/12₆₋₅ |
| Bid winning investor | | | | | |
| ends | | | | | |
| Lending amount | $3,960 | $3,960 | $3,960 | $3,960 | $3,960 |
| Loan interest rate | 10.5% | 10.5% | 10.5% | 10.5% | 10.5% |
| Investment date | Jan. 1, 2018 | Jan. 1, 2018 | Jan. 1, 2018 | Jan. 1, 2018 | Jan. 1, 2018 |
| Specified bank | | | | | |
| account | | | | | |
| The first repayment | Repayment amount | Repayment amount | Repayment amount | Repayment amount | Repayment amount |
| date | Principal $396 + | Principals $396 + | Principal $396 + | Principal $396 + | Principal $396 + |
| Jan. 2, 2018 | Interest $34.65 | Interest $34.65 | Interest $34.65 | Interest $34.65 | Interest $34.65 |
| Grace date | | | | | |
| Apr. 2, 2018 | | | | | |
| The second | Repayment amount | Repayment amount | Repayment amount | Repayment amount | Repayment amount |
| repayment date | Principal $396 + | Principal $396 + | Principal $396 + | Principal $396 + | Principal $396 + |
| Jan. 3, 2018/ | Interest $31.185 | Interest $31.185 | Interest $31.185 | Interest $31.185 | Interest $31.185 |
| Grace date | | | | | |
| Apr. 3, 2018 | | | | | |

At close of the investment date, if the processing module 103 determines that the 6 bid winning investor end 12₆₋₅ does not transfer the lending amount $3,960 to the bank account specified by the fund borrower end 11, and the effectiveness of the fund transaction is affected thereby (i.e. the lending amounts $65,340 that the other bid winning investor ends 12₁₋₁ to 12₆₋₄ have transferred to the bank account are less than the minimum fund borrowing amount $66,000), the processing module 103 immediately produces the notice of transaction suspension, the transmitting module 104 respectively transmits the notice of transaction suspension to the fund borrower end 11 and the 1 to 6 bid winning investor ends 12₁₋₁ to 12₆₋₄, and the fund borrower end 11 shall negotiate with the bid winning investor ends 12₁₋₁ to 12₆₋₄ (having transferred the lending amounts) to determine that the fund transaction is fulfilled or not in the fund transaction platform 10, so as to avoid the dispute on the effectiveness of the fund transaction.

As shown in FIGS. 1 and 4, step S46, at close of each the repayment date, the receiving module 102 receives a plurality of repayment information that the fund borrower end 11 has repaid the amounts of borrowed fund (i.e. principal and interest of each the installment) to bank accounts specified by the 1 to N bid winning investor ends 12₁ to 12_{N}, the processing module 103 determines whether the repaid amounts of borrowed fund in the plurality of repayment information are consistent with the repayment amounts specified in the repayment instructions; if the processing module determines YES, the fulfilling stage goes to step S47, the processing module 103 produces a notice of transaction completion including the remittance information of the 1 to N bid winning investor ends 12₁ to 12_{N} and the repayment information of the fund borrower end 11, the transmitting module 104 respectively transmits the notice of transaction completion to the fund borrower end 11 and the 1 to N bid winning investor ends 12₁ to 12_{N}, and the transaction database 101 stores the data of the fund transaction; if the processing module 103 determines that the repaid amount of borrowed fund in the plurality of repayment information is less than the repayment specified in the repayment instructions, the fulfilling stage goes to step S48, the processing module 103 produces a notice of repayment reminder including an unpaid amount, the transmitting module 104 respectively transmits the notice of repayment reminder to the fund borrower end 11 and the 1 to N bid winning investor ends 12₁ to 12_{N}; step S481, at close of the grace date, the processing module 103 determines whether the fund borrower end 11 has repaid the unpaid amount to the bank account specified by the 1 to N bid winning investor ends 12₁ to 12_{N}; if the processing module 103 determines NO, the fulfilling stage goes to step S482, the processing module 103 produces a notice of transaction termination, the transmitting module 104 respectively transmits the notice of transaction termination to the fund borrower end 11 and the 1 to N bid winning investor ends 12₁ to 12_{N}, and the fund borrower end 11 shall negotiate with the 1 to N bid winning investor ends 12₁ to 12_{N} having not received the repayment and the administrator of the fund transaction platform 10 to determine a solution; if at close of the grace date, the receiving module 102 receives an additional repayment information that the fund borrower end 11 has repaid the unpaid amount (including the delayed principal and interest) to the bank accounts specified by the 1 to N bid winning investor ends 12₁ to 12_{N}, the fulfilling stage goes to step S47, the fund transaction is completed.

In accordance with aforesaid embodiment, the fund transaction platform 10 does not provide or manage an online bank account that the 1 to 6 bid winning investor ends 12₁₋₁ to 12₆₋₅ and the fund borrower end 11 transfer the fund thereto; in principle, the bank accounts used for the fund transaction are specified by the 1 to 6 bid winning investor ends 12₁₋₁ to 12₆₋₅ and the fund borrower end 11. In case that the number of the 1 to N bid winning investor ends 12₁ to 12_{N} is too great, or the fund borrower end 11 provides a real estate as security, the transaction group including the fund borrower end 11 and the 1 to N bid winning investor ends 12₁ to 12_{N} can grant the fund and the real estate trusts to the same financial institution, to reduce the costs of fund transaction, and to increase safety of the fund transaction. In an event that the fund borrower end 11 cannot repay the borrowed fund in accordance with the loan contract, the fund transaction platform 10 is not only able to provide evidences of the fund transaction, but also to assist the 1 to 6 bid winning investor ends 12₁₋₁ to 12₆₋₅ in processing the real estate secured for the fund transaction, to reduce losses of the 1 to 6 bid winning investor ends 12₁₋₁ to 12₆₋₅.

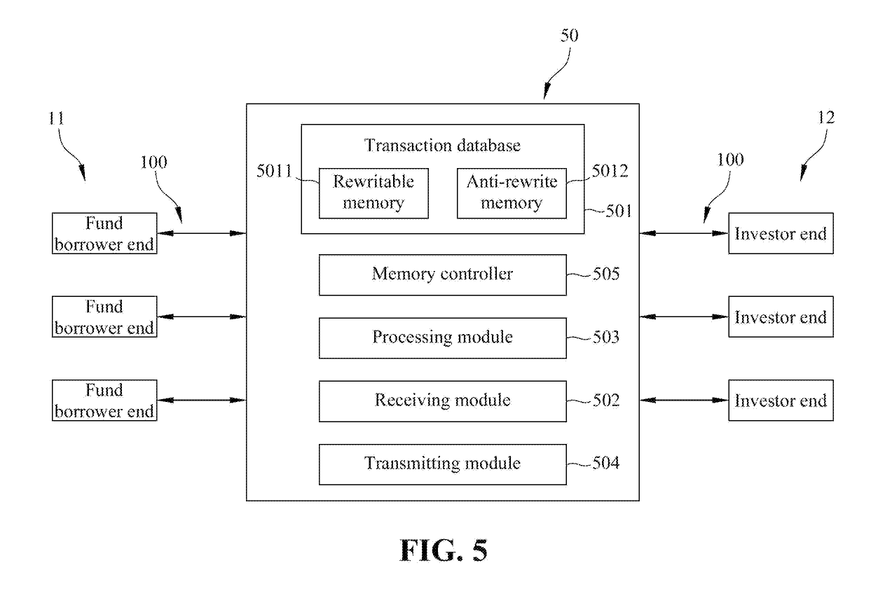

FIG. 5 is a block diagram illustrating a fund transaction platform according to another embodiment of the present application. As shown in FIG. 5, a fund transaction platform 50 includes a transaction database 501, a receiving module 502, a processing module 503, a transmitting module 504 and a memory controller 505, wherein the memory controller 505 respectively connects to the transaction database 501 and the processing module 503. The step flow of the fund borrower end 11 and the investor ends 12 conducting the fund transaction in the fund transaction platform 50 through the network 100 is as described in aforesaid embodiment and FIGS. 2, 3 and 4.

In this embodiment, the transaction database 501 includes a rewritable memory 5011 and an anti-rewrite memory 5012, the rewritable memory 5011 is but not limited to solid state disk (SSD) or hard disk drives (HDD), the anti-rewrite memory 5012 is but not limited to programmable read-only memory (PROM) or one-time programming read-only memory (OTP ROM). The processing module 503 appends a first storage location command to dynamic data including the identity information of the fund borrower end 11 and the investor ends 12, the credit information, the credit limit and investing quota for conducting the fund transaction, the bidding status (as shown in Tables 1, 2 and 3), and transmits the dynamic data to the memory controller 505, the memory controller 505 stores the dynamic data in the rewritable memory 5011 of the transaction database 501 according to the first storage location command. The processing module 503 appends a second storage location command to evidential data including the transaction formed information (as shown in Table 4), the loan contract and the repayment instructions (as shown in Table 5), the remittance information and the repayment information, and transmits the evidential data to the memory controller 505, the memory controller 505 stores the evidential data in the anti-rewrite memory 5012 of the transaction database 501. The evidential data stored in the anti-rewrite memory 5012 can only be read, but cannot be amended or deleted, so as to ensure security and authenticity of the evidential data of the fund transaction.

It is noted that the flow of the fund transaction in aforesaid embodiments are described on a basis of “dozens people investing several hundred thousand dollars in one person”, the fund transaction platform of the present application makes the plurality of investing information correspond to the single fund borrowing information, provides the fund borrowing members and the investing members a transaction mode for freely determining conditions of loan, and solves the technical problems of one-to-many bidding and transaction information security; therefore, more investors (e.g. hundreds of people) can invest higher amounts (e.g. millions of dollars) in single fund borrower under the transaction conditions of low risk and no time-space constrains provided by the fund transaction platform of the present application, so that the targets of low cost, autonomy and high yield that the inclusive finance pursues are achieved.

The exemplary embodiments described above only illustrate the principles and effects of the present application, but are not intended to limit the scope of the present application. Based on the above description, an ordinarily skilled in the art can complete various similar modifications and arrangements according to the technical programs and ideas of the present application, and the scope of the appended claims of the present application should encompass all such modifications and arrangements.

What is claimed is:

1. A fund transaction platform, comprising:
a transaction database, having at least an identity information of a fund borrower end and a plurality of identity information of investor ends stored therein;
a receiving module, receiving at least a fund borrowing information from the fund borrower end and a plurality of investing information corresponding to the fund borrowing information from the investor ends through a network, wherein the fund borrowing information comprises a verification information of the fund borrower end, a minimum fund borrowing amount and a maximum fund borrowing interest rate, each the investing information comprises a verification information of the investor end, an investing amount and an investing interest rate, and each the investing amount is less than the minimum fund borrowing amount;
a processing module, connecting to the transaction database and the receiving module, after determining that the verification information of the fund borrowing information and each the verification information of the investing information are respectively identical to the identity information of the fund borrower end and each the identity information of the investor end, performing steps as follows:
selecting the investing interest rates that are less than the maximum fund borrowing interest rate from the plurality of the investing information, setting the selected investing interest rates less than the maximum fund borrowing interest rate as candidate interest rates, and producing sequence of the candidate interest rates from least to greatest;
accumulating the investing amounts of each the candidate interest rate according to the sequence of the candidate interest rates, and producing cumulative investing amounts corresponding to the sequence of the candidate interest rates;
calculating a difference between each the cumulative investing amount and the minimum fund borrowing amount, and defining the cumulative investing amounts of the differences from greatest negative value to least positive value as 1 to N cumulative investing amounts, wherein N represents an positive integer not less than 2, and the cumulative investing amount which has the difference to the minimum fund borrowing amount being 0 or the least negative value is defined as N−1 cumulative investing amount;
setting the investor ends of which the investing amount are accumulated in the 1 to N cumulative investing amounts as 1 to N bid winning investor ends; and
producing a transaction formed information according to the candidate interest rates and the investing amounts of the 1 to N bid winning investor ends, wherein the transaction formed information comprises at least a loan interest rate, a fund borrowing amount of the fund borrower end and lending amounts of the 1 to N bid winning investor ends; and
a transmitting module, connecting to the processing module, and respectively transmitting the transaction formed information to the fund borrower end and the 1 to N bid winning investor ends through the network.

2. The fund transaction platform according to claim 1, wherein the transaction database has a credit limit of the fund borrower end stored therein, after the processing module determined that the verification information of the fund borrowing information is identical to the identity information of the fund borrower end, the processing module further determines whether the minimum fund borrowing amount is not greater than the credit limit; if the processing module determined yes, the transmitting module transmits the fund borrowing information to the investor ends.

3. The fund transaction platform according to claim 2, wherein the N cumulative investing amount is not greater than the credit limit.

4. The fund transaction platform according to claim 1, wherein the transaction database has an investment quota of each the investor end stored therein, after the processing module determined that the verification information of each the investing information is identical to the identity information of each the investor end, the processing module further determines whether each the investing amount is not greater than each the investment quota; if the processing module determined yes, the processing module selects the investing information of the investing interest rate less than the maximum fund borrowing interest rate, according to the investing information of the investing amount not greater than the investment quota.

5. The fund transaction platform according to claim 1, wherein the transaction database has a fund borrowing page of the fund borrower end and an investing page of each the investor end stored therein, when the fund borrower end inputs the maximum fund borrowing interest rate and the minimum fund borrowing amount in the fund borrowing page to produce the fund borrowing information, the processing module writes the minimum fund borrowing amount in each the investing page; the transmitting module respectively transmits the investing pages having the minimum fund borrowing amount written therein to the investor ends, and each the investor end inputs the investing interest rate and the investing amount in the investing page to produce the investing information corresponding to the fund borrowing information.

6. The fund transaction platform according to claim 1, wherein the fund borrowing information further comprises a bidding deadline; before the bidding deadline, the processing module produces a bidding status table according to the plurality of the received investing information, the transmitting module transmits the bidding status table to each the investor end, and each the investor end can amend the investing interest rate or investing amount of the investing information through the network.

7. The fund transaction platform according to claim 6, when the receiving module receives the investing information amended by the investor end, the processing module updates the bidding status table according to the amended investing information, and the transmitting module transmits the updated bidding status table to each the investor end.

8. The fund transaction platform according to claim 1, wherein the loan interest rate is selected from at least one of the candidate interest rates, and the fund borrowing amount of the fund borrower end is the minimum fund borrowing amount or the N cumulative investing amount.

9. The fund transaction platform according to claim 1, further comprising: a memory controller, respectively connecting to the transaction database and the processing module, wherein the transaction database comprises a rewritable memory and an anti-rewrite memory.

10. The fund transaction platform according to claim 9, wherein the memory controller stores the identity information and the fund-borrowing information of the fund borrower end, and the plurality of identity information and the investing information of the investor ends in the rewritable memory, and stores the transaction formed information in the anti-rewrite memory.
